(19) United States
(12) Patent Application Publication
(10) Pub. No.: US 2012/0330480 A1
(43) Pub. Date: Dec. 27, 2012

(54) VEHICULAR ELECTRONIC CONTROL DEVICE, RELATED INFORMATION ACQUISITION DEVICE, AND METHOD FOR CONTROLLING THE SAME

(75) Inventor: Takafumi NISHISEKO, Kariya-city (JP)

(73) Assignee: DENSO CORPORATION, Kariya-city (JP)

(21) Appl. No.: 13/524,228

(22) Filed: Jun. 15, 2012

(30) Foreign Application Priority Data
Jun. 21, 2011 (JP) 2011-137538

(51) Int. Cl. G06F 7/00

(52) U.S. Cl. 701/1

(57) ABSTRACT

A behavior determination unit determines whether a predetermined vehicle behavior occurs in an own vehicle. A driving information storage unit stores driving information of the own vehicle in a storage portion on determination that the predetermined vehicle behavior occurs. When the predetermined vehicle behavior occurs, a behavior transmission unit transmits behavior occurrence information to an outside of the own vehicle to notify a related information acquisition device, which is around the own vehicle and acquires related information related to the predetermined vehicle behavior, of the occurrence of the predetermined vehicle behavior. In this case, the behavior transmission unit further requires the related information acquisition device to store the acquired related information.

### CROSS REFERENCE TO RELATED APPLICATION

This application is based on reference Japanese Patent Application No. 2011-137538 filed on Jun. 21, 2011, the disclosure of which is incorporated herein by reference.

### TECHNICAL FIELD

The present disclosure relates to a vehicular electronic control device configured to store driving information to analyze a vehicle behavior. The present disclosure further relates to a related information acquisition device configured to acquire related information related to the behavior of a vehicle (behavior-occurrence vehicle) in which the behavior occurs. The present disclosure further relates to a method for controlling the vehicular electronic control device and a method for controlling the related information acquisition device.

### BACKGROUND

Hitherto, as disclosed in U.S. Pat. No. 5,754,965, a technique has been known to diagnose and analyze a vehicle behavior from detection signals of various sensors mounted on a vehicle. In addition, a technique also has been known to store, when a shock is applied to a vehicle due to collision or the like, output information of various sensors before and after the collision, as driving information.

In addition, when an error occurs in a sensor or an actuator, a diagnostic code corresponding to the error state, and sensor output with respect to a time axis and control data at that time are stored as driving information (freeze frame data).

It is noted that, as described above, the diagnostic code and the freeze frame data are stored when an error occurs in a sensor, an actuator, or the like. Accordingly, it is conceivable a situation in which a sensor and an actuator are normal with no errors occurring therein, nevertheless, for example, a vehicle behavior, which does not correspond to the driving operation of a driver, occurs. In such a case, the driving information of the vehicle at that time is not stored. As a result, there is concern that when the vehicle behavior, which does not correspond to the driving operation of the driver, occurs, the cause of the vehicle behavior cannot be analyzed on the basis of the driving information.

### SUMMARY

It is an object of the present disclosure to produce a vehicular electronic control device configured to enable, when a predetermined vehicle behavior occurs, a behavior-occurrence vehicle to appropriately analyze the cause of the occurrence of the predetermined vehicle behavior on the basis of driving information of the behavior-occurrence vehicle and related information which is acquired by a related information acquisition device therearound. It is another object of the present disclosure to produce the related information acquisition device. It is another object of the present disclosure to produce a method for controlling the vehicular electronic control device and a method for controlling the related information acquisition device.

The inventor of the present disclosure has set a predetermined vehicle behavior, and examined a technique of analyzing the cause of the occurrence of the predetermined vehicle behavior on the basis of the stored driving information of a vehicle when the predetermined vehicle behavior occurs. As a result, the inventor of the present disclosure has arrived at the conclusion that it is difficult to appropriately analyze the cause of the occurrence of the predetermined vehicle behavior when only the own vehicle is a driving information source.

For example, it is conceivable a case where a predetermined vehicle behavior occurs in an own vehicle. In such a case, it is impossible to determine, with only the driving information of the own vehicle, whether the vehicle behavior occurs due to a cause unique to the own vehicle when the own vehicle and another vehicle are in the same driving state, or the vehicle behavior occurs when the own vehicle is in a driving state different from that of another vehicle. In addition, it is impossible to determine the cause of the occurrence of the predetermined vehicle behavior, including the surrounding running environment of the own vehicle, from various perspectives with only the driving information of the own vehicle.

In consideration of this, according to an aspect of the present disclosure, a vehicular electronic control device comprises a behavior determination unit configured to determine whether or not a predetermined vehicle behavior occurs in an own vehicle. The vehicular electronic control device further comprises a driving information storage unit configured to store driving information of the own vehicle in a storage portion when the behavior determination unit determines that the predetermined vehicle behavior occurs. The vehicular electronic control device further comprises a behavior transmission unit configured, when the predetermined vehicle behavior occurs, to transmit behavior occurrence information to an outside of the own vehicle to notify a related information acquisition device, which is around the own vehicle and configured to acquire related information related to the predetermined vehicle behavior, of the occurrence of the predetermined vehicle behavior and to require the related information acquisition device to store the related information acquired by the related information acquisition device.

According to another aspect of the present disclosure, a related information acquisition device comprises a behavior acquisition unit configured to acquire behavior occurrence information for notifying occurrence of a predetermined vehicle behavior in a behavior-occurrence vehicle, the behavior-occurrence vehicle being configured to store driving information of the own vehicle in a storage portion when the predetermined vehicle behavior occurs. The related information acquisition device further comprises a related information acquisition unit configured, when the behavior acquisition unit acquires the behavior occurrence information, to acquire related information related to the predetermined vehicle behavior. The related information acquisition device further comprises a related information processing unit configured, when the behavior occurrence information does not instruct the own device to store the related information acquired by the related information acquisition unit, to transmit the related information to an other device configured to store the related information, and when the behavior occurrence information instructs the own device to store the related information, to store the related information in the storage portion.

According to another aspect of the present disclosure, a vehicular electronic control device comprises a behavior determination unit configured to determine whether or not a predetermined vehicle behavior occurs in an own vehicle. The vehicular electronic control device further comprises a driving information storage unit configured to store driving information of the own vehicle in a storage portion when the behavior determination unit determines that the predetermined vehicle behavior occurs. The vehicular electronic control device further comprises a behavior transmission unit configured, when the predetermined vehicle behavior occurs, to transmit behavior occurrence information to an outside of the own vehicle to notify a related information acquisition device, which is around the own vehicle and configured to acquire related information related to the predetermined vehicle behavior, of the occurrence of the predetermined vehicle behavior and to require the related information acquisition device to store the related information acquired by the related information acquisition device. The vehicular electronic control device further comprises a behavior acquisition unit configured to acquire the behavior occurrence information for notifying occurrence of the predetermined vehicle behavior in a behavior-occurrence vehicle, the behavior-occurrence vehicle being configured to store driving information of the own vehicle in the storage portion when the predetermined vehicle behavior occurs. The vehicular electronic control device further comprises a related information acquisition unit configured, when the behavior acquisition unit acquires the behavior occurrence information, to acquire the related information related to the predetermined vehicle behavior. The vehicular electronic control device further comprises a related information processing unit configured, when the behavior occurrence information does not instruct the own device to store the related information acquired by the related information acquisition unit, to transmit the related information to an other device configured to store the related information, and when the behavior occurrence information instructs the own device to store the related information, to store the related information in the storage portion.

### BRIEF DESCRIPTION OF THE DRAWINGS

The above and other objects, features and advantages of the present invention will become more apparent from the following detailed description made with reference to the accompanying drawings. In the drawings:

FIG. 1 is a block diagram showing the circuit configuration of a vehicular electronic control device according to a first embodiment;

FIG. 2 is an explanatory diagram showing a communication state, when a predetermined vehicle behavior occurs, according to the first embodiment;

FIG. 3 is a block diagram showing the functional configuration of the vehicular electronic control device;

FIG. 4 is a block diagram showing the functional configuration of a related information acquisition device;

FIG. 5 is a flowchart showing a process of storing driving information and related information and a process of managing storing driving information and related information;

FIG. 6 is a flowchart showing a predetermined vehicle behavior detection process in the vehicular electronic control device;

FIG. 7 is a flowchart showing storage processes responding to the positional relationship between vehicles;

FIG. 8 is a flowchart showing a storage process according to an example of the positional relationship;

FIG. 9 is a flowchart showing a storage process according to another example of the positional relationship;

FIG. 10 is a flowchart showing a storage process according to further another example of the positional relationship;

FIG. 11 is a flowchart showing a process of storing driving information and related information and a process of managing driving information and related information according to a second embodiment;

FIG. 12 is a block diagram showing a readout process and a deletion process in a related information acquisition device from a remote center, according to the second embodiment;

FIG. 13 is an explanatory diagram showing a communication state, when a predetermined vehicle behavior occurs, according to a third embodiment;

FIG. 14 is a flowchart showing a process of storing driving information and related information and a process of managing driving information and related information, according to the third embodiment; and

FIG. 15 is a block diagram showing a readout process and a deletion process in a related information acquisition device from a scan tool, according to a fourth embodiment.

### DETAILED DESCRIPTION

Hereinafter, embodiments of the present disclosure will be described on the basis of the drawings.

### First Embodiment

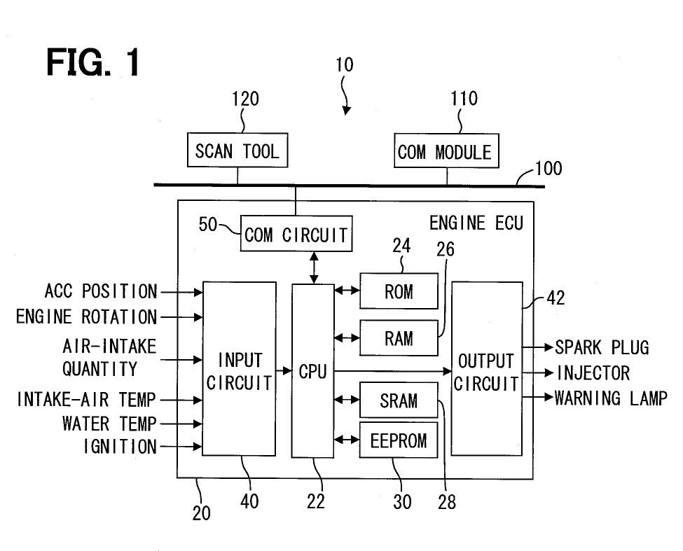

FIG. 1 shows a diagnosis system 10 according to a first embodiment. The diagnosis system 10 includes an engine electronic control unit (ECU) 20, a communication module 110, and a scan tool 120. The ECU 20 is connected to the communication module 110 and the scan tool 120 via an in-vehicle LAN such as a controller area network (CAN) bus 100 to communicate therewith.

The ECU 20 includes a CPU 22, a ROM 24, a RAM 26, a SRAM (standby RAM) 28, an EEPROM 30, an input circuit 40, an output circuit 42, a communication circuit 50, and the like.

The ECU 20 inputs detection signals such as an accelerator opening (accelerator position), the number of engine rotations, an air-intake quantity, an intake-air temperature, a water temperature, ignition—ON or ignition—OFF, and the like through the input circuit 40 from various sensors and the like when the CPU 22 executes a control program stored in the ROM 24. In addition, on the basis of these detection signals, a control signal for control in fuel injection of an injector (not shown), control in ignition of a spark plug, control in lighting of a warning lamp, or the like is output through the output circuit 42.

Unlike the RAM 26, which is used for work for the control program of the ECU 20 and in which, when an ignition switch is turned off, stored data is lost since the supply of electricity is interrupted, the SRAM 28 is supplied with electricity from a battery (not shown) regardless of ON/OFF of the ignition switch. Accordingly, the data which is stored in the SRAM 28 is preserved as long as the supply of electricity is not interrupted due to the reason such as replacement of the battery.

The EEPROM 30 is a rewritable non-volatile storage portion. Even when the supply of electricity from the battery is interrupted, the data which is stored in the EEPROM 30 is preserved. The communication circuit 50 is used to communicate with another ECU mounted on the vehicle via the in-vehicle LAN such as the CAN bus 100, communicate with another external device of the vehicle via the communication module 110, and communicate with the scan tool 120 via the CAN bus 100.

The communication module 110 communicates with the outside of the vehicle wirelessly by a request from the ECU mounted on the vehicle. The scan tool 120 is connected to the vehicle by a dealer or in a repair factory or the like to read out a diagnostic code from each ECU through the CAN bus 100 and to read out or delete, from the ECU 20, driving information when a predetermined vehicle behavior occurs. Hereinafter, the predetermined vehicle behavior to be described later is sometimes referred to as “predetermined vehicle behavior.” The scan tool 120 outputs the read-out information to a display and the like.

Functions of Vehicles, Remote Center, and Roadside Device

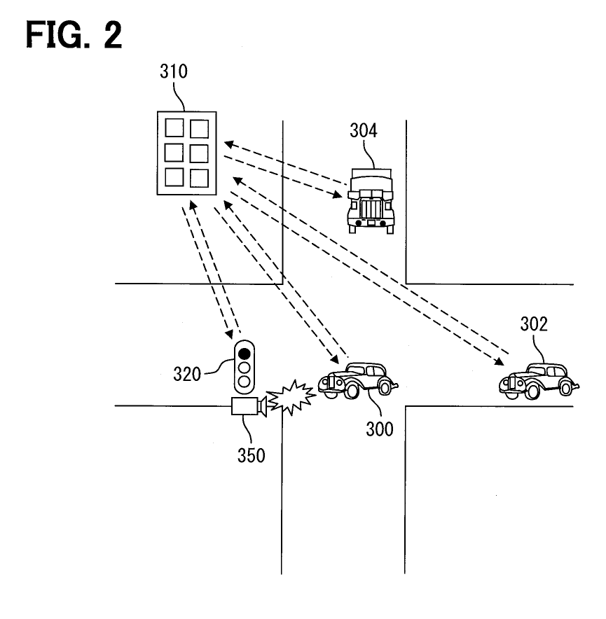

Next, functions which are executed by vehicles 300, 302, and 304, a remote center 310, and a roadside device 320 when a predetermined vehicle behavior occurs will be described (see FIG. 2). In FIG. 2, traffic lights are illustrated as a roadside device 320 installed on the road on which vehicles run. However, the roadside device is not limited to the traffic lights if related information related to a predetermined vehicle behavior occurring in a vehicle (behavior-occurrence vehicle) can be acquired around the behavior-occurrence vehicle.

Function of Behavior-Occurrence Vehicle

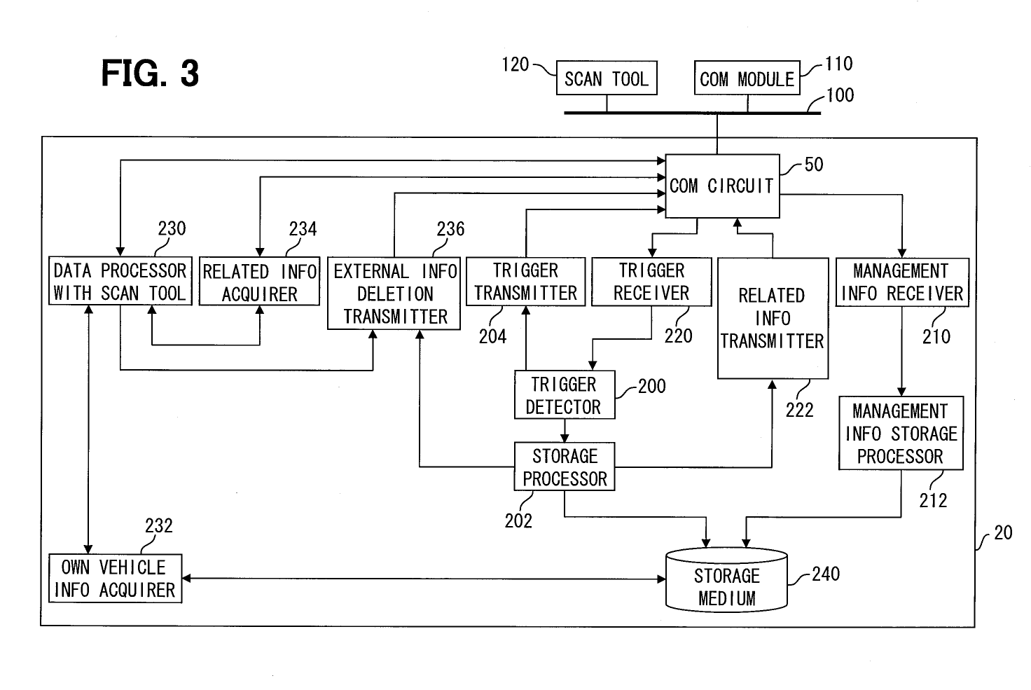

First, functions of the vehicles 300, 302, and 304 in which a predetermined vehicle behavior occurs or in which related information is acquired will be described with reference to FIG. 3. The ECU 20 with the function shown in FIG. 3 is also mounted on all of the vehicles 300, 302, and 304. In FIG. 2, the vehicle 300 is a vehicle in which a predetermined vehicle behavior occurs, and the vehicles 302 and 304 are vehicles in which related information is acquired.

A trigger detection portion 200 detects the occurrence of a predetermined vehicle behavior on the basis of detection signals of various sensors. The following behaviors (1) to (3) are set in advance as the predetermined vehicle behavior. Among (1) to (3), the predetermined vehicle behaviors shown in (1) and (2) are vehicle behaviors which do not correspond to the operation of a driver.

(1) The rate of increase in the vehicle speed is a predetermined value or higher even when an accelerator pedal is not depressed.

(2) The number of engine rotations rapidly increases to 2,000 rpm or higher even when a shift range is set to neutral.

(3) The detected value of an acceleration sensor is a predetermined value or higher due to collision or the like.

When the trigger detection portion 200 detects the occurrence of a predetermined vehicle behavior in an own vehicle, a storage processing portion 202 acquires driving information of the vehicle at that time, such as an accelerator opening, the number of engine rotations, a throttle opening, the shift position of a transmission, an air-intake quantity, an intake-air temperature, a water temperature, and a vehicle speed, and stores the information in a storage medium 240.

In the present embodiment, as the storage medium 240 which stores the driving information when a predetermined vehicle behavior occurs, the EEPROM 30 is used which holds stored data even when the driving of a vehicle is stopped. As a replacement for the EEPROM 30, the SRAM 28 may be used.

In a configuration an on-board camera or navigation device is mounted, the image data captured by the on-board camera, the running state of another vehicle around the vehicle based on the result of the analysis of the image data, the shape of the road on which the vehicles runs such as a curvature and a gradient based on map data information, and the like may be stored as the driving information, in addition to the information indicating the driving state of the vehicle detected from the various sensors.

When a predetermined vehicle behavior occurs and driving information is stored in the storage medium 240, the storage processing portion 202 instructs an external information deletion transmission portion 236 to delete related information related to the driving information to be overwritten, in the case where the capacity of the storage medium 240 runs short and the driving information stored in the past is overwritten. The related information will be described later.

In addition, when the trigger detection portion 200 detects the occurrence of a predetermined vehicle behavior, a trigger transmission portion 204 notifies the fact that the predetermined vehicle behavior has occurred in an own vehicle, and transmits behavior occurrence information to the remote center 310 through the communication circuit 50 and the communication module 110 to request the storage of related information related to the predetermined vehicle behavior occurring in the own vehicle. In this case, a remote center 310 which is the closest to the behavior-occurrence vehicle may receive the behavior occurrence information from the behavior-occurrence vehicle, or a prespecified remote center 310 may receive the behavior occurrence information from the behavior-occurrence vehicle.

The trigger transmission portion 204 transmits, as a part of the behavior occurrence, information, the position of the own vehicle, the vehicle identification number (VIN) for specifying the own vehicle, the classification of the predetermined vehicle behavior, and the like. The position of the own vehicle is acquired from the on-board navigation device using a global positioning system (GPS). The classification of the predetermined vehicle behavior will be described later.

A management information reception portion 210 receives, from the remote center 310, a center number of the remote center 310 and a data number of the related information stored in the remote center 310, as management information of the related information related to the predetermined vehicle behavior occurring in the own vehicle.

A management information storage processing portion 212 stores the center number and the data number received by the management information reception portion 210 in the storage medium 240. In this case, the EEPROM 30 is used as the storage medium 240.

Function of Vehicles in which Related Information is Acquired

When a trigger reception portion 220 receives the behavior occurrence information from the remote center 310, the trigger detection portion 200 detects the occurrence of a predetermined vehicle behavior in another vehicle.

When the trigger detection portion 200 detects the occurrence of a predetermined vehicle behavior in another vehicle, the storage processing portion 202 transmits the VIN of the own vehicle and related information such as the driving state acquired in the same manner as in the case of the behavior-occurrence vehicle, the surrounding image data captured by an on-board camera, and the shape of the road on which the vehicles run from a navigation device to the remote center 310 through the communication circuit 50 and the communication module 110 from a related information transmission portion 222.

In the case of the vehicles, the driving information stored in the vehicle in which the predetermined vehicle behavior occurs may be the same as the related information which is acquired by the vehicle in which the related information is acquired.

Function of Remote Center 310

When receiving the behavior occurrence information from the behavior-occurrence vehicle, an electronic controller (not shown) of the remote center 310 instructs another vehicle and the roadside device 320 around the behavior-occurrence vehicle to acquire related information related to the predetermined vehicle behavior occurring in the behavior-occurrence vehicle.

The remote center 310 receives the related information related to the predetermined vehicle behavior occurring in the vehicle-occurrence vehicle from another vehicle and the roadside device 320. The remote center 310 further receives, in the case of the vehicle, the VIN, and in the case of the roadside device, the device number. With the VIN of the behavior-occurrence vehicle and the time at which the behavior occurs, the received information is stored as one data entry with a data number assigned thereto, and a management table is created.

In addition, the remote center 310 transmits, as management information, its center number and the data number of the related information related to the predetermined vehicle behavior occurring in the behavior-occurrence vehicle to the behavior-occurrence vehicle.

When receiving the center number and the data number from the behavior-occurrence vehicle and receiving a request for reading out the related information, the remote center 310 transmits the related information of the corresponding data number to the behavior-occurrence vehicle.

In addition, when receiving the center number and the data number from the behavior-occurrence vehicle and receiving a request for deleting the related information, the remote center 310 deletes the data of the corresponding data number.

Function of Roadside Device 320

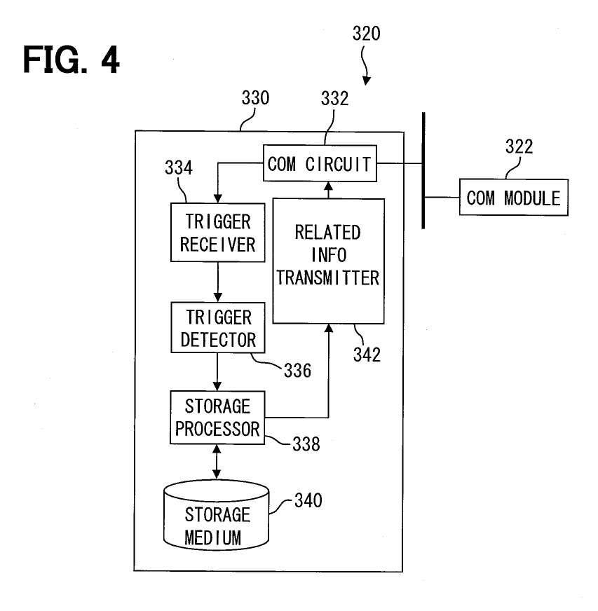

As shown in FIG. 4, in a related information acquisition device 330 which is an electronic controller of the roadside device 320, when a trigger reception portion 334 receives the behavior occurrence information as a trigger from the remote center 310 through a communication module 322 and a communication circuit 332, a trigger detection portion 336 detects the occurrence of a predetermined vehicle behavior in the surrounding vehicles.

When the trigger detection portion 336 detects the occurrence of a predetermined vehicle behavior in the surrounding vehicles, a storage processing portion 338 transmits the device number for specifying the own device and related information such as the surrounding image data captured by a camera 350 (see FIG. 2), and in the case of a vehicle information and communication system (VICS: registered trade name), the traffic information at that time to the remote center 310 through the communication circuit 332 and the communication module 322 from a related information transmission portion 342. In a storage medium 340, the image data and traffic information are stored for a predetermined time and the like.

In the present embodiment, since it is preferable that the image data and traffic information for a predetermined time and the like are transmitted from the related information acquisition device 330 when the behavior occurrence information is received from the remote center 310, there is no need for the storage medium 340 of the related information acquisition device 330 to be non-volatile.

Function of Reading Out or Deleting Data in Behavior-Occurrence Vehicle

As shown in FIG. 3, in the ECUs 20 of the vehicles 300, 302, and 304, when a data processing portion 230 associated with the scan tool 120 is instructed to read out the driving information of the own vehicle from the scan tool 120, an own vehicle information acquisition portion 232 acquires the driving information stored in the storage medium 240 and the management information of the related information.

The data processing portion 230 transmits the driving information and the management information, which are acquired from the storage medium 240 by the own vehicle information acquisition portion 232, to the scan tool 120 through the communication circuit 50. In addition, regarding another vehicle, when the scan tool 120 instructs the data processing portion 230 to read out the related information related to the predetermined vehicle behavior occurring in the own vehicle, a related information acquisition portion 234 transmits a center number and a data number to the remote center 310 through the communication circuit 50, and requires the corresponding remote center 310 to read out the related information.

The center number and the data number transmitted to the remote center 310 by the related information acquisition portion 234 are included in management information which is read out in advance from the storage medium 240 by the scan tool 120 and transmitted to the related information acquisition portion 234.

When the related information acquisition portion 234 acquires the related information from the remote center 310, the data processing portion 230 transmits the acquired related information to the scan tool 120. When the data processing portion 230 receives a request from the scan tool 120 to delete external data, or receives a request from the storage processing portion 202 to delete external data, the external information deletion transmission portion 236 instructs the remote center 310 to delete the data of the corresponding data number.

The center number and the data number which are transmitted at this time to the remote center 310 by the external information deletion transmission portion 236 are included in management information which is read out in advance from the storage medium 240 by the scan tool 120 and transmitted to the external information deletion transmission portion 236, or management information which is acquired from the storage processing portion 202.

In addition, as described above, in the case when a predetermined vehicle behavior occurs at this time, the driving information stored in the past in the storage medium 240 is overwritten since the storage capacity of the storage medium 240 runs short, the external information deletion transmission portion 236 instructs, by an instruction from the storage processing portion 202, the remote center 310 to delete the data of the data number of the related information related to the driving information to be overwritten.

Process of Storing Driving Information and Related Information

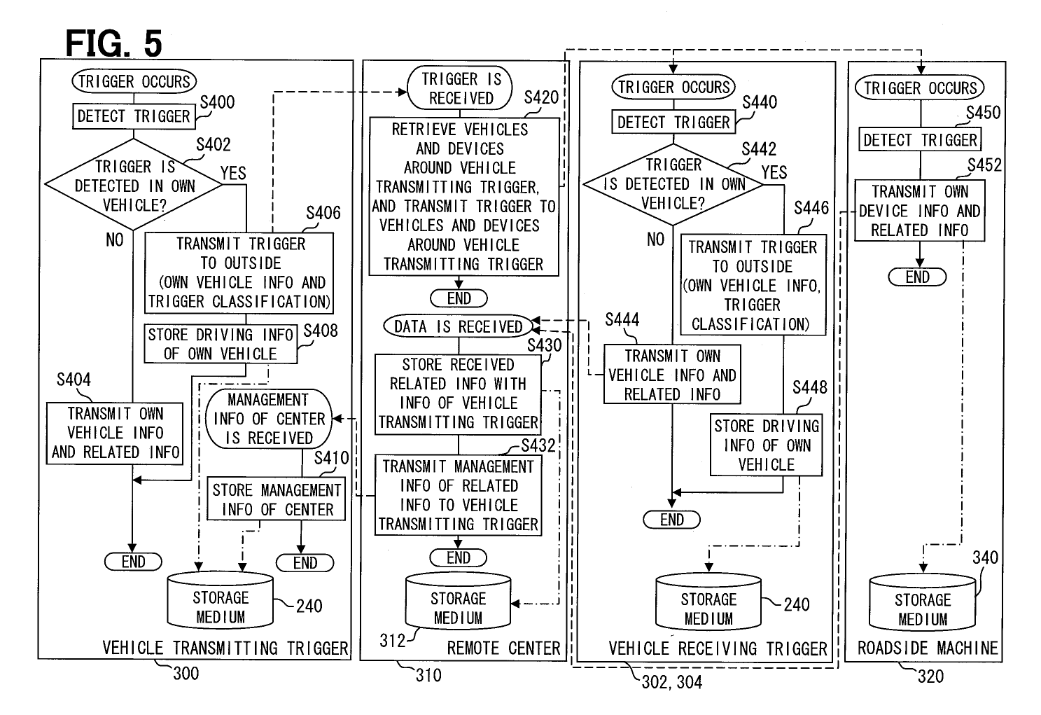

Next, a process of storing the driving information and the related information, which is executed by the vehicles 300, 302 and 304, the remote center 310, and the roadside device 320 when a predetermined vehicle behavior occurs, will be described with reference to the flowcharts of FIG. 5. In FIG. 5, “S” represents a step. In FIG. 5, the vehicle 300 is a vehicle in which the behavior occurs, and the vehicles 302 and 304 are vehicles in which related information is acquired.

Process of Vehicle 300

When a predetermined vehicle behavior (trigger) is detected (S400), the ECU 20 determines whether or not the detected trigger is detected in the own vehicle (S402).

When the detected trigger is detected in the own vehicle (S402: Yes), the ECU 20 transmits, to the remote center 310, the classification of the trigger, the position of the own vehicle, the VIN of the own vehicle, and a storage instruction for storing related information related to the predetermined vehicle behavior as behavior occurrence information (S406). The transmission of the behavior occurrence information may correspond to the instruction for storing the related information.

Since FIG. 5 assumes that the predetermined vehicle behavior occurs in the vehicle 300, the determination in S402 results in “Yes”. The process in S404 which is executed when the determination in S402 results in “No” will be omitted since it is substantially the same as S444 to be described later.

After S406, the ECU 20 stores driving information of the own vehicle in the storage medium 240 (S408). As described above, image data, running states of another vehicle based on the result of the analysis of the image data, a road shape based on map data information, and the like may be stored as driving information with a driving state which is detected by various sensors.

In addition, when receiving management information for managing the related information from the remote center 310, the ECU 20 stores the received management information in the storage medium 240 (S410). The management information which is received from the remote center 310 includes a center number of the remote center 310 and a data number, stored in the remote center 310, of the related information related to the predetermined vehicle behavior occurring in the vehicle 300.

By receiving and storing the management information for managing the related information from the remote center 310, the driving information which is stored in the own vehicle when the predetermined vehicle behavior occurs and the related information which is stored outside the behavior-occurrence vehicle in relation to the predetermined vehicle behavior can be managed in the behavior-occurrence vehicle.

Process of Remote Center 310

When receiving the behavior occurrence information as a trigger from the behavior-occurrence vehicle 300, the remote center 310 retrieves, on the basis of the position information received from the behavior-occurrence vehicle 300, vehicles, roadside devices and the like around the behavior-occurrence vehicle 300 by an inquiry through communication, or in the case of roadside devices, by a registered database, and instructs the corresponding vehicles and roadside devices to acquire and transmit the related information to the remote center 310 in S420.

When receiving the related information together with the VIN or the device number from the vehicles 302 and 304, the roadside device 320 and the like around the behavior-occurrence vehicle 300, the remote center 310 stores the VIN of the behavior-occurrence vehicle 300, the time at which the predetermined vehicle behavior occurs, the VINs and device numbers of the vehicles, roadside devices and the like transmitting the related information, and the related information in a storage medium 312 of the remote center 310 in S430.

As management information of the stored information, a center number and a data number of the stored data are transmitted to the behavior-occurrence vehicle 300 (S432).

Processes of Vehicles 302 and 304

When the trigger is detected (S440), the ECUs 20 of the vehicles 302 and 304 determine whether or not the detected trigger is detected in the own vehicle (S442). Since FIG. 5 assumes that the predetermined vehicle behavior occurs in the vehicle 300, the determination in S442 results in “No”.

When the detected trigger is not detected in the own vehicle (S442: No), the ECU 20 transmits the VIN of the own vehicle and related information such as the driving state of the own vehicle, the image data captured by an on-board camera, and the driving information of the own vehicle including a road shape acquired from a navigation device to the remote center 310 (S444).

The processes in S446 and S448 in the vehicles 302 and 304 are substantially the same as the processes in S406 and S408 in the vehicle 300.

Process of Roadside device 320

When the trigger is detected (S450), the roadside device 320 transmits the device number of the own device and related information such as the surrounding traffic information and the image data captured by the camera 350 to the remote center 310 (S452). In FIG. 5, the roadside device 320 temporarily stores the related information in the storage medium 340 to transmit the related information acquired by the own device.

Trigger Detection Process

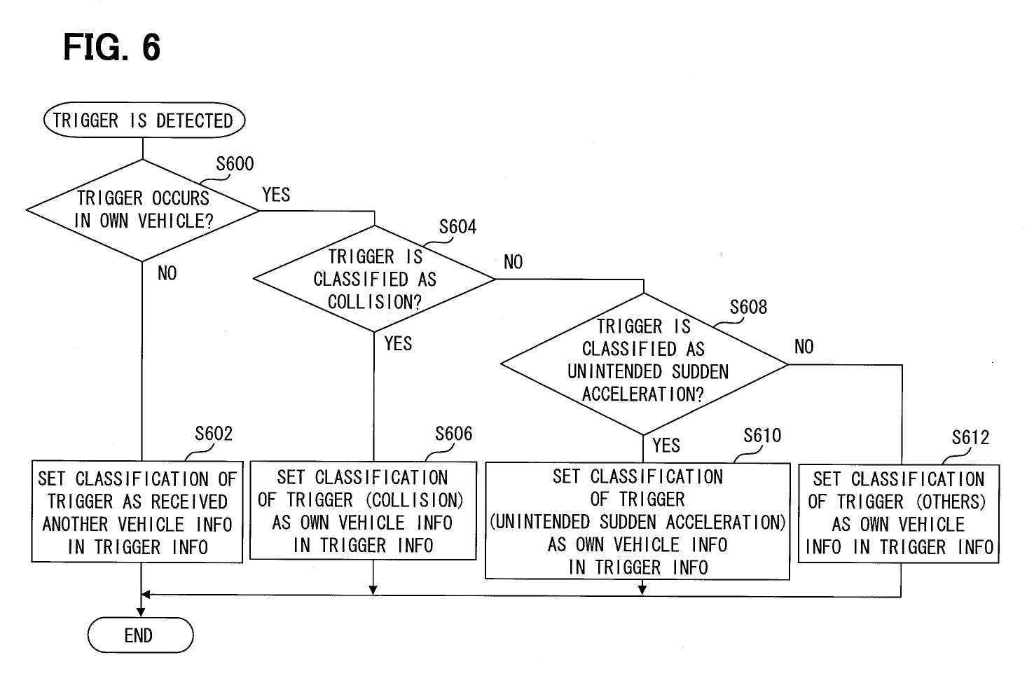

The trigger detection process which is executed in S400, S440, and S450 of FIG. 5 will be described on the basis of the flowchart of FIG. 6.

When the occurrence of a predetermined vehicle behavior as a trigger is detected, it is determined whether or not the trigger occurs in an own vehicle (S600). When the trigger does not occur in the own vehicle (S600: No), the trigger occurs in another vehicle. Accordingly, the received VIN of another vehicle and classification of the trigger are set as trigger information.

The predetermined vehicle behavior (trigger) is classified into plural items in accordance with the condition of the occurrence of the trigger. In the present embodiment, when it is determined that an acceleration equal to or higher than a predetermined value is applied to the vehicle from the detection signal of an acceleration sensor, the trigger is classified as “collision”, and when it is determined that in a state in which the accelerator opening is fully closed, the vehicle speed has a rate of increase equal to or higher than a predetermined value from the detection signal of a vehicle speed sensor, the trigger is classified as “unintended sudden acceleration”. Other triggers are collectively classified as “other”.

In the roadside device 320, the determination in S600 always results in “No”. For convenience of description, the process is described as a trigger detection process common to the vehicles 300, 302, and 304, and the roadside device 320. In the case where the trigger occurs in the own vehicle (S600: Yes), when the classification of the trigger is “collision” (S604: Yes), the VIN of the own vehicle and “collision” as the classification of the trigger are set as trigger information (S606).

When the classification of the trigger is not “collision” (S604: No), nevertheless is “unintended sudden acceleration” (S608: Yes), the VIN of the own vehicle and “unintended sudden acceleration” as the classification of the trigger are set as trigger information (S610).

When the classification of the trigger is neither “collision” nor “unintended sudden acceleration” (S604: No, S608: No), the VIN of the own vehicle and “other” as the classification of the trigger are set as trigger information (S612).

Related Information Storage Process

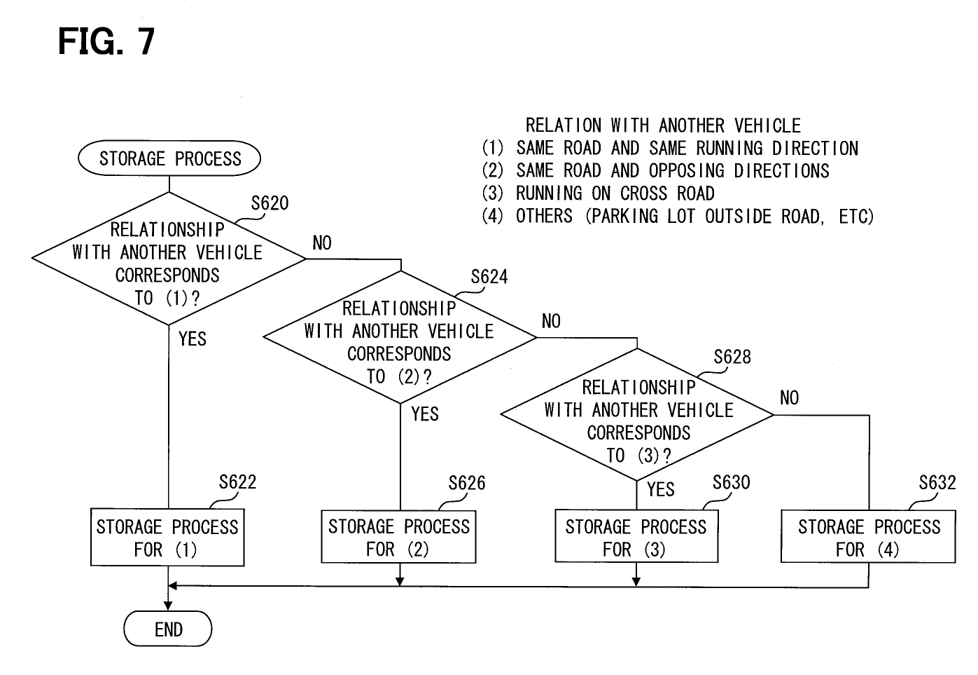

The related information storage process which is executed to transmit the related information in S404 and S444 of FIG. 5 in a vehicle in which the related information is acquired will be described on the basis of the flowchart of FIG. 7. In the related information storage process which is executed to transmit the related information in S404, S444, and S452 to be described later, the stored related information is transmitted to the remote center 310. Accordingly, a volatile RAM or the like may be used as a storage medium to store the related information.

The positional relationship between a behavior-occurrence vehicle in which a predetermined, vehicle behavior occurs and an own vehicle is determined in S620, S624, and, S628, and a storage process responding to each positional relationship is executed (S622, S626, S630, and S632).

The positional relationship between a behavior-occurrence vehicle and an own vehicle is determined from the image data of a drive recorder, an on-board camera and the like, the detection of a car in front by radar, the position of the behavior-occurrence vehicle which is acquired from the remote center 310 as a part of the behavior occurrence information, the position of the own vehicle which is acquired from a navigation device mounted on the own vehicle, and the like.

Storage Process 1

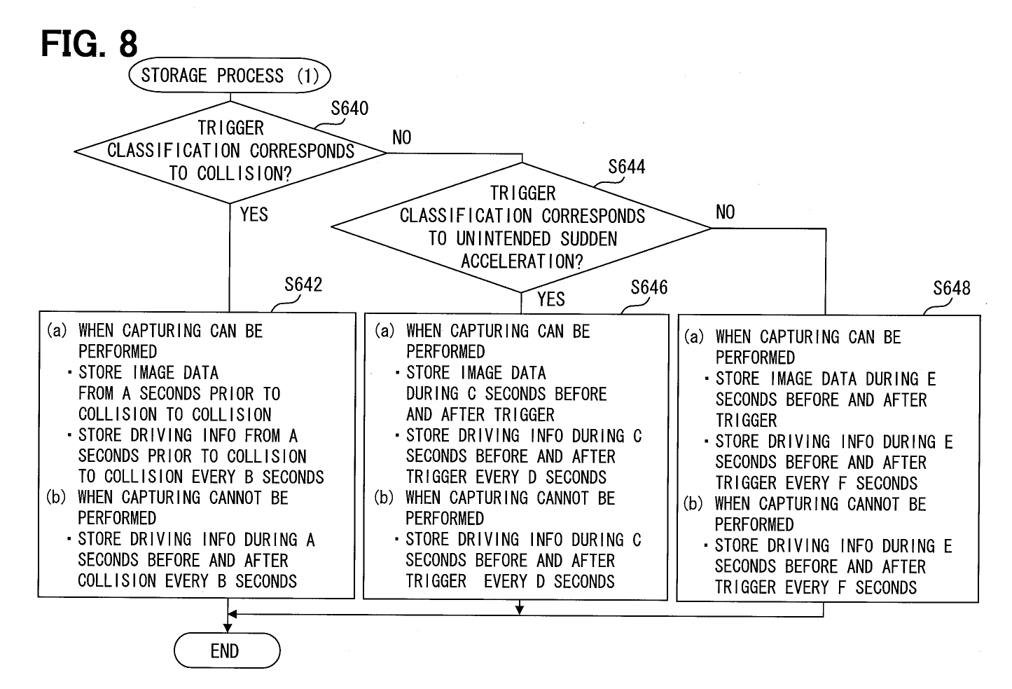

A storage process 1 which is executed in S622 of FIG. 7 when a positional relationship is established in which the behavior-occurrence vehicle in which the trigger occurs and the own vehicle run in the same direction on the same road will be described on the basis of the flowchart of FIG. 8.

When the classification of the trigger is “collision” (S640: Yes), the following related information is stored in accordance with whether or not capturing can be performed by a camera mounted on the own vehicle (S642).

(1) In the Case where Capturing can be Performed

Image data from A seconds prior to the collision to the collision is stored. Furthermore, driving information of the own vehicle from A seconds prior to the collision to the collision is stored every B seconds.

(2) In the Case where Capturing Cannot be Performed

Driving information of the own vehicle during A seconds before and after the collision is stored every B seconds.

When the classification of the trigger is not “collision” (S640: No), nevertheless is unintended sudden acceleration (S644: Yes), the following related information is stored in accordance with whether or not capturing can be performed by a camera mounted on the own vehicle (S646).

(1) In the Case where Capturing can be Performed

Image data during C seconds before and after the trigger is stored. Furthermore, driving information during C seconds before and after the trigger is stored every D seconds.

(2) In the Case where Capturing Cannot be Performed

Driving information of the own vehicle during C seconds before and after the trigger is stored every D seconds.

When the classification of the trigger is not “collision (S640: No), and also not unintended sudden acceleration (S644: No), the following related information is stored in accordance with whether or not capturing can be performed by a camera mounted on the own vehicle (S648).

(1) In the Case where Capturing can be Performed

Image data during E seconds before and after the trigger is stored. Furthermore, driving information during E seconds before and after the trigger is stored every F seconds.

(2) In the Case where Capturing Cannot be Performed

Driving information of the own vehicle during E seconds before and after the trigger is stored every F seconds.

Storage Process 2

A storage process 2 which is executed in S626 of FIG. 7 when a positional relationship is established in which the behavior-occurrence vehicle in which the trigger occurs and the own vehicle run in opposing directions on the same road will be omitted because it is substantially the same as above, except for the number of seconds which is set in each of the processes in S642, S646, and S648 of FIG. 8.

Storage Process 3

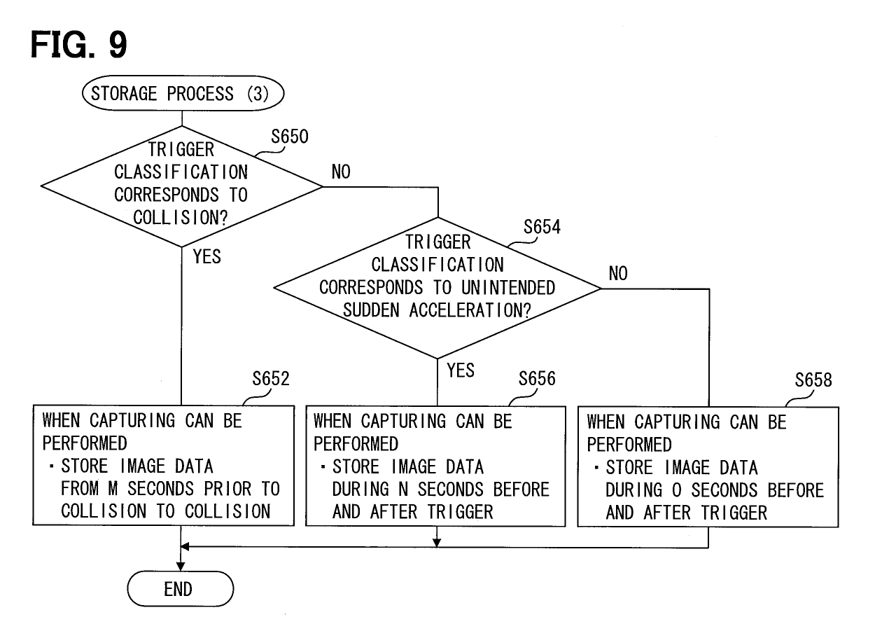

A storage process 3 which is executed in S630 of FIG. 7 when a positional relationship is established in which the behavior-occurrence vehicle in which the trigger occurs and the own vehicle run on a cross road will be described on the basis of the flowchart of FIG. 9. When the behavior-occurrence vehicle and the own vehicle run on a cross road, these are different in running environment such as a signal and a surrounding vehicle running state. Accordingly, it is thought that the driving information of the own vehicle has little relation with the behavior of the behavior-occurrence vehicle. Therefore, when the behavior-occurrence vehicle and the own vehicle run on a cross road, the driving information of the own vehicle is not stored.

When the classification of the trigger is “collision” (S650: Yes), and capturing can be performed by a camera mounted on the own vehicle, image data from M seconds prior to the collision to the collision is stored (S652). When the classification of the trigger is not “collision (S650: No), nevertheless is unintended sudden acceleration (S654: Yes), image data during N seconds before and after the trigger is stored (S656).

When the classification of the trigger is not “collision” (S650: No), and also not unintended sudden acceleration (S654: No), and capturing can be performed by a camera mounted on the own vehicle, image data during O seconds before and after the trigger is stored (S658).

Storage Process 4

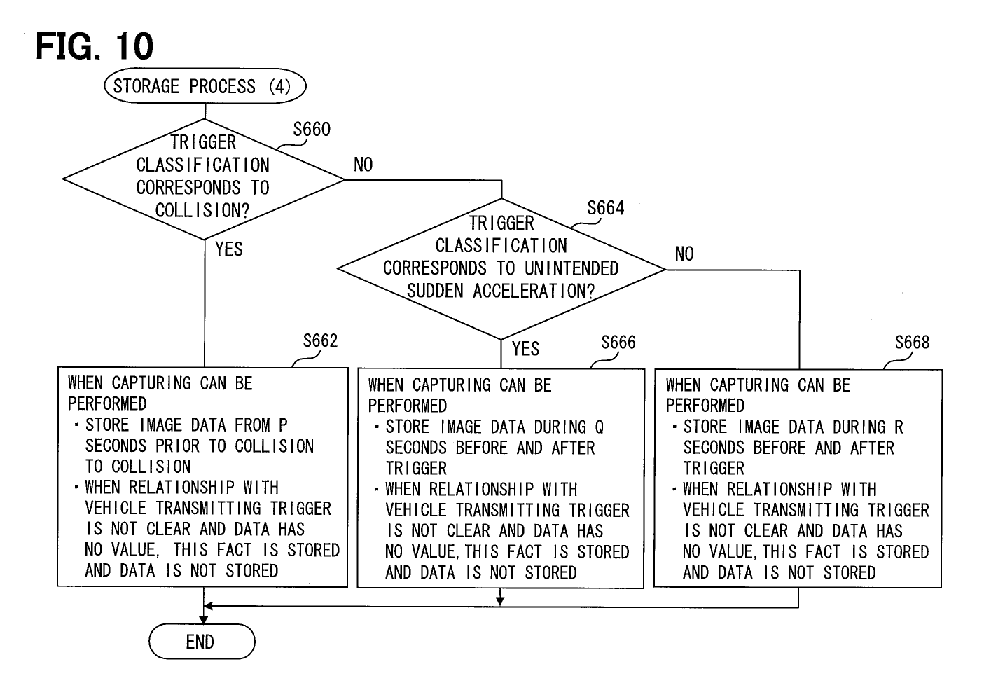

A storage process 4 which is executed in S632 of FIG. 7 when, for example, a positional relationship is established in which the own vehicle parks in a parking lot close to a road on which the behavior-occurrence vehicle runs will be described on the basis of the flowchart of FIG. 10.

When the own vehicle parks, it is thought that the driving information of the own vehicle has little relation with the behavior of the behavior-occurrence vehicle. Accordingly, when the own vehicle parks, the driving information of the own vehicle is not stored.

When the classification of the trigger is “collision” (S660: Yes), and capturing can be performed by a camera mounted on the own vehicle, image data from P seconds prior to the collision to the collision is stored (S662). However, in the case where the own vehicle is present around the behavior-occurrence vehicle, nevertheless the positional relationship therebetween is not clear, for example, in the case where whether or not the behavior-occurrence vehicle is present in a capturing direction of the camera is not clear, when it is possible to reach a judgment that the running vehicle is not captured in the image data and it is highly probable that the behavior-occurrence vehicle is not captured, the fact that the image data is not stored is stored.

When the classification of the trigger is not “collision” (S660: No), nevertheless is unintended sudden acceleration (S664: Yes), and capturing can be performed by a camera mounted on the own vehicle, image data during Q seconds before and after the trigger is stored (S666). Also in this case, when the positional relationship between the behavior-occurrence vehicle and the own vehicle is not clear, the fact that the image data is not stored is stored.

When the classification of the trigger is not “collision (S660: No), and also not unintended sudden acceleration (S664: No), and capturing can be performed by a camera mounted on the own vehicle, image data during R seconds before and after the trigger is stored (S668). Also in this case, as described above, when the positional relationship between the behavior-occurrence vehicle and the own vehicle is not clear, the fact that the image data is not stored is stored.

Storage Process of Roadside Device 320

In the roadside device 320, the related information storage process which is executed to transmit the related information in S452 of FIG. 5 is substantially the same as the storage process 4 of FIG. 10 in view of the fact that the driving information is not stored and the image data is not stored when the positional relationship with the behavior-occurrence vehicle is not clear.

When the captured image data is analyzed and a vehicle showing an unusual behavior is captured, it is desirable to perform an appropriate image process, such as raising the resolution and moving the vehicle showing the unusual behavior to the center of the image, in accordance with the importance degree of the image data.

In the above-described first embodiment, even when a sensor or actuator is not broken, when a predetermined vehicle behavior occurs in the own vehicle, the ECU 20 stores the driving information at that time. Furthermore, the ECU 20 transmits, to the remote center 310, the behavior occurrence information to notify the fact that the predetermined vehicle behavior has occurred and the related information related to the predetermined vehicle behavior is stored.

Accordingly, the remote center 310 can instruct another vehicle, the roadside device and the like around the behavior-occurrence vehicle to acquire the related information related to the predetermined vehicle behavior and to transmit the related information to the remote center 310. In addition, when the scan tool 120 which is connected to the behavior-occurrence vehicle by a dealer or the like issues an instruction for reading out the related information, the related information can be read out from the remote center 310.

As a result, on the basis of the driving information stored in the behavior-occurrence vehicle and the related information acquired by another vehicle, the roadside device and the like around the behavior-occurrence vehicle, the cause of the occurrence of the predetermined vehicle behavior can be determined from various perspectives.

In addition, since the behavior-occurrence vehicle communicates with the remote center 310 and does not communicate with an unspecified number of other vehicles, roadside devices and the like, the communication load and the processing load of the behavior-occurrence vehicle can be reduced.

In addition, since the related information which is acquired by another vehicle, the roadside device and the like around the behavior-occurrence vehicle is transmitted to the remote center 310 and the remote center 310 stores the related information, it is possible to prevent an EEPROM from being used as, for example, a rewritable non-volatile storage portion to store the related information in another vehicle, the roadside device, and the like.

In addition, in the behavior-occurrence vehicle, when the driving information is stored at this time, in the case where the driving information which is stored already in the storage medium 240 is overwritten due to an insufficient storage capacity, management information such as a center number and a data number stored in relation to the driving information to be overwritten is transmitted to the remote center 310, and an instruction is issued to the remote center 310 to delete the related information related to the driving information to be overwritten.

Accordingly, on the basis of the management information transmitted from the behavior-occurrence vehicle, the remote center 310 can delete the related information stored in the remote center 310 in relation to the driving information to be overwritten. As a result, it is possible to prevent storing unnecessary data in the remote center 310.

In addition, when an instruction for deleting the related information is issued from the scan tool 120, the deletion instruction can be transmitted to the remote center 310 from the behavior-occurrence vehicle, and the related information can be deleted.

In the first embodiment, the ECU 20 of the behavior-occurrence vehicle corresponds to the vehicular electronic control device of the present disclosure, the storage medium 240 corresponds to the storage portion of the vehicular electronic control device of the present disclosure, the scan tool 120 corresponds to the scan tool of the present disclosure, the remote center 310 corresponds to the remote center of the present disclosure, the electronic control device (not shown) of the remote center 310 which receives the related information from the vehicles 302 and 304 and the roadside device 320 corresponds to another device of the present disclosure, and the ECU 20 of the vehicle in which the related information is acquired and the related information acquisition device 330 of the roadside device 320 correspond to the related information acquisition device of the present disclosure.

The ECU 20 functions as the behavior determination unit, the driving information storage unit, the behavior transmission unit, the information management unit, the behavior acquisition unit, the related information acquisition unit, and the related information processing unit of the present disclosure. In addition, the related information acquisition device 330 functions as the behavior acquisition unit, the related information acquisition unit, and the related information processing unit.

In addition, the VIN of the behavior-occurrence vehicle corresponds to the own vehicle information for specifying the own vehicle of the present disclosure, and the VIN of the vehicle in which the related information is acquired and the device number of the roadside device 320 correspond to the device information for specifying the related information acquisition device of the present disclosure.

In FIG. 3 of the present embodiment, the trigger detection portion 200 functions as the behavior determination unit of the present disclosure, the trigger detection portion 200 and the trigger reception portion 220 function as the behavior acquisition unit of the present disclosure, the storage processing portion 202 functions as the driving information storage unit and the related information acquisition unit of the present disclosure, the trigger transmission portion 204 functions as the behavior transmission unit of the present disclosure, the management information reception portion 210, the management information storage processing portion 212, the data processing portion 230, the own vehicle information acquisition portion 232, the related information acquisition portion 234, and the external information deletion transmission portion 236 function as the information management unit of the present disclosure, and the related information transmission portion 222 functions as the related information processing unit of the present disclosure.

In addition, in FIG. 4 of the present embodiment, the trigger reception portion 334 and the trigger detection portion 336 function as the behavior acquisition unit of the present disclosure, the storage processing portion 338 functions as the related information acquisition unit of the present disclosure, and the related information transmission portion 342 functions as the related information processing unit of the present disclosure.

In addition, the processes in S400, S402, S440, and S442 of FIG. 5 correspond to the function which is executed by the behavior determination unit of the present disclosure, the processes in S406 and S446 correspond to the function which is executed by the behavior transmission unit of the present disclosure, the processes in S408 and S448 correspond to the function which is executed by the driving information storage unit of the present disclosure, the processes in S404, S444, and S452 correspond to the function which is executed by the related information acquisition unit and the related information processing unit of the present disclosure, the process in S410 corresponds to the function which is executed by the information management unit of the present disclosure, and the processes in S440 and S450 correspond to the function which is executed by the behavior acquisition unit of the present disclosure.

In addition, the processes in S600 and S604 to S612 of FIG. 6 correspond to the function which is executed by the behavior determination unit of the present disclosure, and the process in S602 corresponds to the function which is executed by the behavior acquisition unit of the present disclosure.

In addition, all of the processes of FIGS. 7 to 10 correspond to the function which is executed by the related information acquisition unit of the present disclosure.

### Second Embodiment

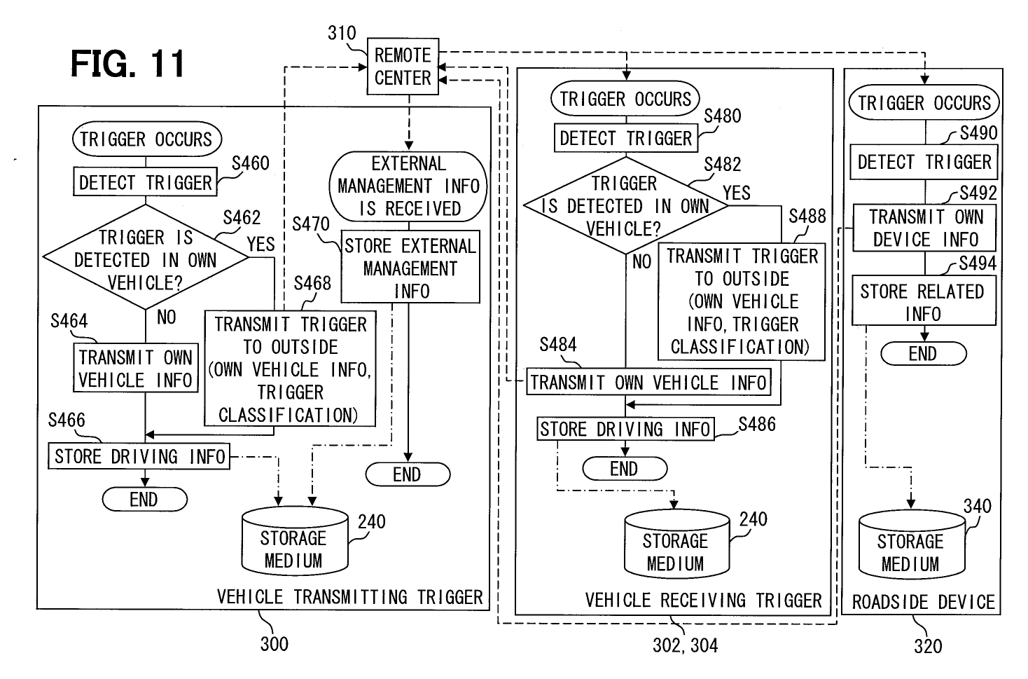

A process of storing driving information and related information according to a second embodiment will be described on the basis of the flowchart of FIG. 11. In FIG. 11, “S” represents a step. The second embodiment is different from the flowchart of FIG. 5 of the first embodiment in view of the fact that the related information acquired by vehicles 302 and 304 and a roadside device 320 is not stored in a remote center 310, nevertheless is stored in the vehicles 302 and 304 and the roadside device 320. As in FIG. 5, the vehicle 300 is a vehicle in which a behavior occurs, and the vehicles 302 and 304 are vehicles in which related information is acquired in FIG. 11.

Process of Vehicle 300

When a trigger indicating the occurrence of a predetermined vehicle behavior is detected (S460), an ECU 20 determines whether or not the detected trigger is detected in the own vehicle (S462).

When the detected trigger is detected in the own vehicle (S462: Yes), the ECU 20 transmits, to the remote center 310, the classification of the trigger, the position of the own vehicle, the VIN of the own vehicle, and an instruction for storing related information as behavior occurrence information (S468), and stores driving information of the own vehicle in a storage medium 240 (S466). Since FIG. 11 assumes that the predetermined vehicle behavior occurs in the vehicle 300, the determination in S462 results in “Yes”. The process in S464 which is executed when the determination in S462 results in “No” will be omitted since it is substantially the same as S484 to be described later.

In addition, in S470, when acquiring the related information by an external related information acquisition device of the own vehicle and receiving management information from the remote center 310, the ECU 20 stores the management information in the storage medium 240. The management information received from the remote center 310 includes the VINs of the vehicles 302 and 304 which store the related information, and the device number of the roadside device 320 which stores the related information.

The behavior-occurrence vehicle 300 can manage driving information, which is stored in the own vehicle when a predetermined vehicle behavior occurs, and related information, which is stored outside the behavior-occurrence vehicle in relation to the predetermined vehicle behavior, in relation to each other by receiving and storing, in the case of the vehicular electronic control device, the VIN of the vehicle on which the vehicular electronic control device is mounted, and in the case of the roadside device, the device number from the remote center 310 as device information for specifying the related information acquisition device which acquires and stores the related information outside the own vehicle.

Process of Remote Center 310

When receiving the behavior occurrence information as a trigger from the vehicle 300 in which the predetermined vehicle behavior occurs, the remote center 310 retrieves vehicles, roadside devices and the like around the vehicle 300 on the basis of the position information of the vehicle 300, and instructs the corresponding vehicles 302 and 304 and the corresponding roadside device 320 to acquire and store the related information.

In addition, when the VIN and the information for specifying the vehicle or the device such as a device number are transmitted from the vehicles 302 and 304 and the roadside device 320 which store the related information, the VIN and the device number are transmitted to the vehicle 300 which is a behavior-occurrence vehicle.

Processes of Vehicles 302 and 304

When the trigger indicating the occurrence of a predetermined vehicle behavior is detected (S480), the ECU 20 determines whether or not the detected trigger is detected in the own vehicle (S482). Since FIG. 11 assumes that the predetermined vehicle behavior occurs in the vehicle 300, the determination in S482 results in “No”.

When the detected trigger is not detected in the own vehicle (S482: No), the ECU 20 transmits the VIN of the own vehicle to the remote center 310 (S484), and stores, as related information, the driving information of the own vehicle, the image data captured by an on-board camera, and the like in the storage medium 240 together with the VIN of the behavior-occurrence vehicle 300 and a time at which the behavior occurs (S486). The process in S488 which is executed when the determination in S482 results in “Yes” is substantially the same as the above-described S468.

Process of Roadside Device 320

When the trigger indicating the occurrence of a predetermined vehicle behavior is detected (S490), the roadside device 320 transmits the device number of the own device to the remote center 310 (S492), and stores, as related information, the surrounding traffic information and the image data captured by a camera 350 in a storage medium 340 of the roadside device 320 (S494).

Process of Reading Out or Deleting Data

In the second embodiment, when the related information which is stored in the storage media of the vehicles 302 and 304 and the roadside device 320 is read out or deleted from the behavior-occurrence vehicle 300, by an instruction from the behavior-occurrence vehicle 300, the remote center 310 instructs the vehicles 302 and 304 and the roadside device 320 to read out or delete the related information.

Data Readout

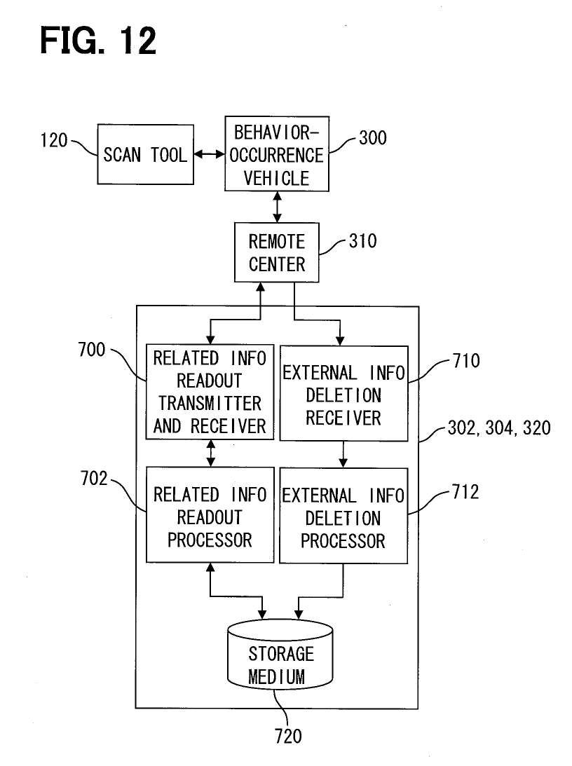

As shown in FIG. 12, the readout of related information is executed by an instruction from a scan tool 120 connected to the behavior-occurrence vehicle 300. When an instruction is issued to read out related information from the scan tool 120, the behavior-occurrence vehicle 300 transmits the VIN of the own vehicle, the VINs of the vehicles 302 and 304 which store the related information, the device number of the roadside device 320, and an instruction for reading out the related information to the remote center 310.

The remote center 310 transmits the VIN of the behavior-occurrence vehicle 300 and the instruction for reading out the related information to the vehicles 302 and 304 and the roadside device 320 which are designated to store the related information from the behavior-occurrence vehicle 300.

When receiving the instruction for reading out the related information from the remote center 310, related information readout transmission and reception portions 700 of the vehicles 302 and 304 and the roadside device 320 instruct a related information readout processing portion 702 to read out the related information corresponding to the behavior-occurrence vehicle 300 from a storage medium 720.

When the related information readout processing portion 702 reads out the related information corresponding to the behavior-occurrence vehicle 300 from the storage medium 720, the related information readout transmission and reception portion 700 transmits the related information to the remote center 310 together with the VIN or the device number.

The remote center 310 transmits the related information received from the vehicles 302 and 304 and the roadside device 320, and VIN, and the device number to the behavior-occurrence vehicle 300.

Data Deletion

Regarding deletion of related information, when an instruction is issued from the scan tool 120 connected to the behavior-occurrence vehicle 300, or the previous driving information is overwritten in the behavior-occurrence vehicle 300, the vehicles 302 and 304 and the roadside device 320 which store the related information related to the driving information to be overwritten are instructed to delete the related information.

The behavior-occurrence vehicle 300 transmits the VIN of the own vehicle, the VINs of the vehicles 302 and 304 which store the related information, the device number of the roadside device 320, and an instruction for deleting the related information to the remote center 310.

The remote center 310 transmits the VIN of the behavior-occurrence vehicle 300 and the instruction for deleting the related information to the vehicles 302 and 304 and the roadside device 320 which are designated to store the related information from the behavior-occurrence vehicle 300.

When receiving the instruction for deleting the related information from the remote center 310, external information deletion reception portions 710 of the vehicles 302 and 304 and the roadside device 320 instruct an external information deletion processing portion 712 to delete the related information corresponding to the VIN of the behavior-occurrence vehicle 300 from the storage medium 720. The external information deletion processing portion 712 deletes the related information corresponding to the VIN of the behavior-occurrence vehicle 300 from the storage medium 720.

Deletion of Other Data

In the vehicles 302 and 304, it is thought that in a state in which the related information related to a predetermined vehicle behavior occurring in the vehicle 300 is stored, a predetermined vehicle behavior occurs in the vehicles 302 and 304 and driving information is stored in the storage medium 240.

In addition, when the related information stored in the storage medium 240 is overwritten due to an insufficient storage capacity, the vehicles 302 and 304 issue an instruction to the vehicle 300 through the remote center 310 to delete the management information related to the related information to be overwritten.

That is, in the processing configuration in which the reference numeral 300 is changed to the reference numerals 302 and 304, and the reference numerals 302, 304, and 320 are changed to the reference numeral 300 in FIG. 12, the vehicles 302 and 304 instruct the vehicle 300 to delete the management information.

In the second embodiment, the storage media 240 of the vehicles 302 and 304 and the storage medium 340 of the roadside device 320 correspond to the storage portion which stores the related information. The related information readout transmission and reception portions 700, the related information readout processing portion 702, the external information deletion reception portion 710, and the external information deletion processing portion 712 of the vehicles 302 and 304 and the roadside device 320 correspond to the function which is executed by the related information management unit of the related information acquisition device of the present disclosure.

In addition, the processes in S460, S462, S480, and S482 of FIG. 11 correspond to the function which is executed by the behavior determination unit of the present disclosure, the processes in S468 and S488 correspond to the function which is executed by the behavior transmission unit of the present disclosure, the processes in S466 and S486 correspond to the function which is executed by the driving information storage unit and the related information processing unit of the present disclosure, the processes in S464 and S484 correspond to the function which is executed by the related information processing unit of the present disclosure, the process in S470 corresponds to the function which is executed by the information management unit of the present disclosure, the processes in S480 and S490 correspond to the function which is executed by the behavior acquisition unit of the present disclosure, and the processes in S492 and S494 correspond to the function which is executed by the related information processing unit of the present disclosure.

In the second embodiment, when the ECU 20 of the behavior-occurrence vehicle is broken and replaced by a dealer or the like, the management information of the related information stored in the ECU 20 may be read out by the dealer, and in place of the behavior-occurrence vehicle 300 in FIG. 12, a communication terminal device or the like of the dealer may issue an instruction on the basis of the read-out management information to the vehicles 302 and 304 and the roadside device 320 through the remote center 310 to read out or delete the related information.

### Third Embodiment

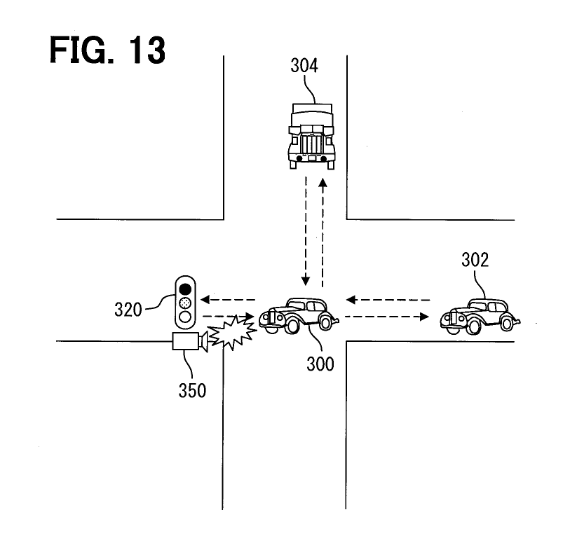

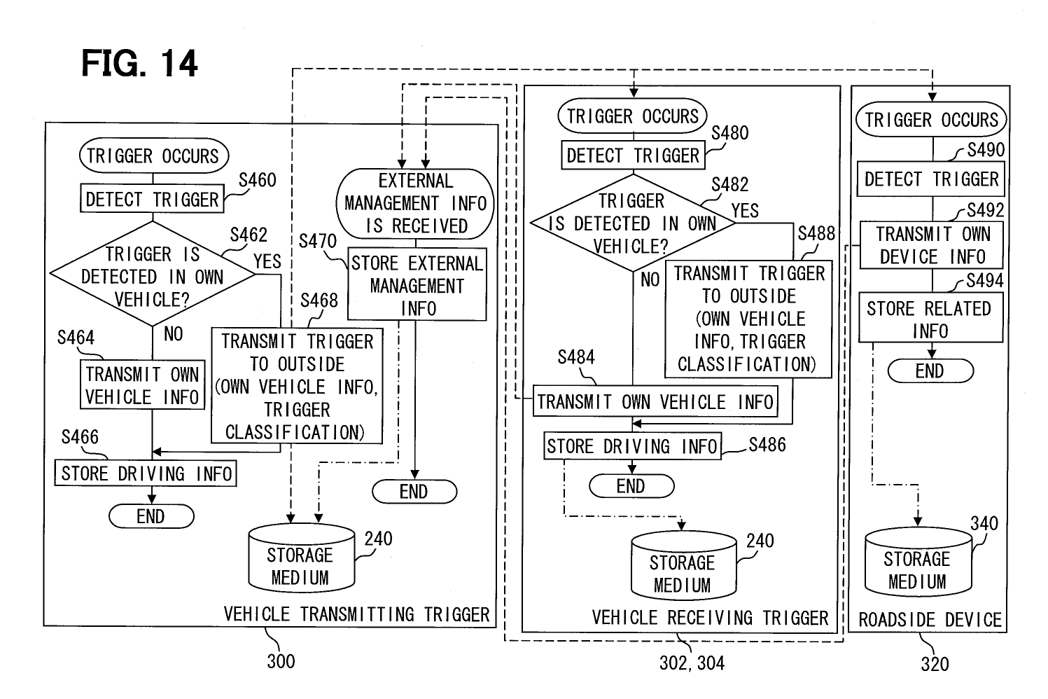

A process of storing driving information and related information according to a third embodiment will be described with reference to FIGS. 13 and 14.

Storage Process

In the third embodiment, as shown in FIG. 13, a vehicle 300 which is a behavior-occurrence vehicle, and vehicles 302 and 304 and a roadside device 320 which are vehicles in which related information is acquired directly communicate with each other through vehicle-vehicle communication and road-vehicle communication, not through a remote center 310.

A process of storing driving information and related information shown in the flowchart of FIG. 14 is substantially the same as the flowchart shown in FIG. 11, except that the vehicle 300 directly communicates with the vehicles 302 and 304 and the roadside device 320 through vehicle-vehicle communication and road-vehicle communication, not through the remote center 310.

In the third embodiment, since the vehicle 300 directly communicates with the vehicles 302 and 304 and the roadside device 320, the vehicles 302 and 304 and the roadside device 320 can acquire and store related information by an instruction from the vehicle 300 even when the remote center 310 cannot be used.

Process of Reading Out or Deleting Data

In the third embodiment, in the case where related information which is stored in storage media of the vehicle 302 and 304 and the roadside device 320 is read out by an instruction from a scan tool 120, and in the case where when driving information which is stored in the behavior-occurrence vehicle is overwritten by an instruction from the scan tool 120, or due to an insufficient storage capacity, an instruction is issued to delete related information which is stored in the storage media of the vehicle 302 and 304 and the roadside device 320, in FIG. 12, an instruction is issued directly, not through the remote center 310, from the behavior-occurrence vehicle 300 to the vehicles 302 and 304 and the roadside device 320 to read out or delete the related information.

In addition, in the case where related information is overwritten due to an insufficient storage capacity in the vehicles 302 and 304 in which the related information is acquired, in FIG. 12, an instruction is issued directly, not through the remote center 310, from the vehicles 302 and 304 to the behavior-occurrence vehicle 300 to delete management information which is stored in the storage medium of the behavior-occurrence vehicle 300 to manage the related information to be overwritten.

### Fourth Embodiment

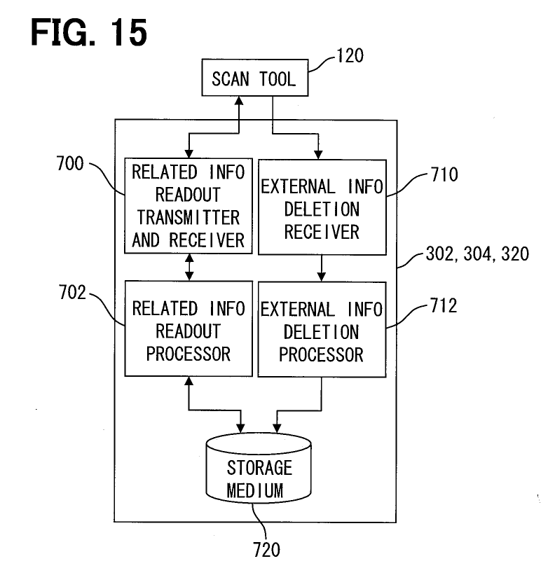

In a fourth embodiment shown in FIG. 15, when vehicles 302 and 304 and a roadside device 320 which store related information are identified from the VIN and device number which are stored in a behavior-occurrence vehicle 300 as management information, a scan tool 120 is directly connected to the corresponding vehicles 302 and 304 and the corresponding roadside device 320, so that the scan tool 120 reads out or deletes related information which is stored in storage media of the vehicles 302 and 304 and the roadside device 320.

The process is substantially the same as the process of reading out or deleting related information described in FIG. 12, except that the scan tool 120 directly instructs the vehicles 302 and 304 and the roadside device 320 to read out or delete the related information.

### Other Embodiments

In the above-described embodiments, the description mainly in which the vehicle 300 is a behavior-occurrence vehicle, and the vehicles 302 and 304 are vehicles in which related information is acquired has been given. However, the ECU 20 of any vehicle has a function of the vehicular electronic control device of the present disclosure as a behavior-occurrence vehicle and a function of the related information acquisition device of the present disclosure as a vehicle in which related information is acquired.

On the other hand, the ECU of each vehicle may have a function of the vehicular electronic control device of the present disclosure as a behavior-occurrence vehicle or a function of the related information acquisition device of the present disclosure as a vehicle in which related information is acquired.

An on-board ECU which stores driving information of an own vehicle when a predetermined vehicle behavior occurs and transmits the fact that the predetermined vehicle behavior has occurred to the outside of the own vehicle is not limited to the engine ECU 20, and may be another ECU.

In addition, the storage portion which stores driving information of the vehicle when a predetermined vehicle behavior occurs may be any storage portion if it can hold data even during stop of the driving of the vehicle as in the case of the EEPROM 30 and the SRAM 28.

The present disclosure may be applied to any of a vehicle which has an internal-combustion engine such as a gasoline engine or a diesel engine as a drive source, a hybrid vehicle with a combination of an internal-combustion engine and a motor, and an electric car which has a motor as a drive source.

Summarizing the above-described embodiments, to begin with, the inventor of the present disclosure has set a predetermined vehicle behavior, and examined a technique of analyzing the cause of the occurrence of the predetermined vehicle behavior on the basis of the stored driving information of a vehicle when the predetermined vehicle behavior occurs. As a result, the inventor of the present disclosure has arrived at the conclusion that it is difficult to appropriately analyze the cause of the occurrence of the predetermined vehicle behavior when only the own vehicle is a driving information source.

For example, in the case where a predetermined vehicle behavior occurs in an own vehicle, whether the vehicle behavior occurs due to a cause unique to the own vehicle when the own vehicle and another vehicle are in the same driving state, or the vehicle behavior occurs when the own vehicle is in a driving state different from that of another vehicle cannot be determined with only the driving information of the own vehicle. In addition, the cause of the occurrence of the predetermined vehicle behavior, including the surrounding running environment of the own vehicle, cannot be determined from various perspectives with only the driving information of the own vehicle.

In consideration of these facts, according to the above disclosure, when the behavior determination unit determines that a predetermined vehicle behavior occurs in an own vehicle, the driving information storage unit stores driving information of the own vehicle in a storage portion. In addition, when the predetermined vehicle behavior occurs, the behavior transmission unit notifies a related information acquisition device around the own vehicle which acquires related information related to the predetermined vehicle behavior of the occurrence of the predetermined vehicle behavior, and transmits behavior occurrence information to the outside of the own vehicle to request the storage of the related information acquired by the related information acquisition device.

In this manner, when a predetermined vehicle behavior occurs in an own vehicle, behavior occurrence information is transmitted to the outside of the own device not only to store driving information of the own vehicle, nevertheless also to store related information related to the predetermined vehicle behavior which is acquired by the related information acquisition device around the own vehicle. Accordingly, in addition to the driving information of the own vehicle, the related information which is acquired by the related information acquisition device around the own vehicle can be stored. Accordingly, the cause of the occurrence of the predetermined vehicle behavior can be appropriately analyzed from various perspectives on the basis of much information including the running environment around the own vehicle in comparison to analysis with only the driving information of the own vehicle.

The behavior transmission unit may transmit the behavior occurrence information to a remote center to indirectly notify the related information acquisition device from the remote center of the occurrence of the predetermined vehicle behavior, may require the remote center or the related information acquisition device to store the related information, and may instruct the remote center to manage the related information.

In this manner, since the behavior occurrence information is transmitted to the remote center and the remote center is instructed to manage the related information acquired by the related information acquisition device, the related information processing load and the communication load can be reduced in comparison to a case in which the vehicular electronic control device of a behavior-occurrence vehicle in which a predetermined vehicle behavior occurs communicates with an unspecified number of related information acquisition devices and manages the related information acquired by the related information acquisition devices.

The information management unit may acquire management information for managing the related information from the remote center and store the management information in the storage portion. Accordingly, the driving information stored in the own vehicle and the related information acquired by the related information acquisition device can be managed in relation to each other in the own vehicle on the basis of the management information acquired from the remote center.

However, in the case where when the predetermined vehicle behavior occurs, the previous driving information which is stored already is overwritten due to an insufficient storage capacity, the related information which is stored outside the own vehicle in relation to the driving information of the own vehicle to be overwritten is not required.

Accordingly, in the case where the driving information which is stored already in the storage portion is overwritten when the driving information storage unit stores the driving information at this time, the information management unit may transmit the management information which is stored in relation to the driving information to be overwritten to the remote center, and may instruct the remote center to delete the related information related to the driving information to be overwritten.

Accordingly, the remote center can delete, on the basis of the management information transmitted from the behavior-occurrence vehicle, the related information which is stored in the remote center or the related information acquisition device in relation to the driving information to be overwritten. As a result, it is possible to prevent storing unnecessary data in the remote center and the related information acquisition device.

The information management unit may acquire, on the basis of the management information stored in the storage portion, the related information acquired by the related information acquisition device from the remote center by an instruction from a scan tool which is connected to the own vehicle by communication, and may instruct the remote center to delete the related information by an instruction from the scan tool.

In addition, the information management unit may acquire, on the basis of the device information for specifying the related information acquisition device which is stored in the storage portion, the related information stored in the related information acquisition device from the related information acquisition device by an instruction from a scan tool which is connected to the own vehicle by communication, and may instruct the related information acquisition device to delete the related information by an instruction from the scan tool.

In this manner, on the basis of the management information or the device information stored in the vehicular electronic control device, the related information can be easily read out or deleted by an instruction from the scan tool.

The behavior transmission unit may directly notify the related information acquisition device of the occurrence of the predetermined vehicle behavior and may request the storage of the related information by transmitting the behavior occurrence information to the related information acquisition device.

In this manner, since the behavior occurrence information is directly transmitted to the related information acquisition device, the related information acquisition device can be instructed to acquire and store the related information even when the remote center cannot be used.

The information management unit may acquire device information for specifying the related information acquisition device from the related information acquisition device and may store the device information in the storage portion. Accordingly, the driving information which is stored in the own vehicle and the related information which is acquired by and stored in the related information acquisition device can be managed in relation to each other on the basis of the device information in the own vehicle.

In the case where the driving information which is stored already in the storage portion is overwritten when the driving information storage unit stores the driving information at this time, the information management unit may transmit the device information which is stored in relation to the driving information to be overwritten to the related information acquisition device, and may instruct the related information acquisition device to delete the related information related to the driving information to be overwritten.

Accordingly, when the driving information is overwritten in the behavior-occurrence vehicle in which the predetermined vehicle behavior occurs, the related information acquisition device can delete, on the basis of the device information which is transmitted from the behavior-occurrence vehicle, the data which is stored in the related information acquisition device in relation to the driving information to be overwritten. As a result, it is possible to prevent storing unnecessary data in the related information acquisition device.

The behavior determination unit may determine which one of plural classifications which are set in advance in accordance with the condition of the occurrence of the predetermined vehicle behavior which has occurred corresponds to, and the behavior transmission unit may transmit, as a part of the behavior occurrence information, the classification of the predetermined vehicle behavior which is determined by the behavior determination unit.

Accordingly, in accordance with the classification of the predetermined vehicle behavior acquired from the behavior-occurrence vehicle, the related information acquisition device can acquire the appropriate related information related to the predetermined vehicle behavior. For example, it is thought that the length of time used for and the frequency of acquiring the related information are adjusted in response to the classification of the predetermined vehicle behavior.

The behavior transmission unit may transmit own vehicle information for specifying the own vehicle as a part of the behavior occurrence information. Accordingly, the related information acquired by the related information acquisition device and the notified own vehicle information can be managed in relation to each other in the device storing the related information.

The behavior acquisition unit may acquire behavior occurrence information to notify of the occurrence of a predetermined vehicle behavior in a behavior-occurrence vehicle which stores driving information of the own vehicle in a storage portion when the predetermined vehicle behavior occurs, the related information acquisition unit may acquire related information related to the predetermined vehicle behavior when the behavior acquisition unit acquires the behavior occurrence information, and the related information processing unit may transmit the related information to another device which stores the related information when the behavior occurrence information does not instruct the own device to store the related information acquired by the related information acquisition unit, and may store the related information in the storage portion when the behavior occurrence information instructs the own device to store the related information.

In this manner, when the predetermined vehicle behavior occurs in the behavior-occurrence vehicle, not only the driving information is stored in the behavior-occurrence vehicle, nevertheless also the related information related to the predetermined vehicle behavior occurring in the behavior-occurrence vehicle is acquired by the related information acquisition device disposed outside the behavior-occurrence vehicle, and the acquired related information is stored in another device or the related information acquisition device disposed outside the behavior-occurrence vehicle. Accordingly, by the driving information stored in the behavior-occurrence vehicle and the related information acquired by the related information acquisition device, the cause of the occurrence of the predetermined vehicle behavior in the behavior-occurrence vehicle can be appropriately analyzed from various perspectives on the basis of much information including the running environment around the behavior-occurrence vehicle.

The behavior acquisition unit may indirectly acquire, from a remote center, the behavior occurrence information which is transmitted from the behavior-occurrence vehicle. In this manner, since the behavior occurrence information which is transmitted from the behavior-occurrence vehicle can be aggregated and acquired through the remote center, the processing load and the communication load can be reduced in comparison to the case in which the related information related to the predetermined vehicle behavior occurring in the behavior-occurrence vehicle is acquired by communication with an unspecified number of behavior-occurrence vehicles.

The behavior acquisition unit may indirectly acquire the behavior occurrence information from the remote center, and when the behavior occurrence information does not instruct the own device to store the related information, the related information processing unit may transmit the related information to the remote center provided with the above-mentioned device.

Accordingly, the related information acquisition device just acquires the related information, and is not required to store the related information, and thus using the storage portion of the related information acquisition device to store the related information can be prevented.

The related information processing unit may transmit device information for specifying the own device to the remote center.

Accordingly, the behavior-occurrence vehicle and the device information of the related information acquisition device can be managed in relation to each other in the remote center, or the device information of the related information acquisition device can be transmitted to the behavior-occurrence vehicle from the remote center, and the driving information at the time when the predetermined vehicle behavior occurs and the device information can be managed in relation to each other in the behavior-occurrence vehicle.

The behavior acquisition unit may directly receive, from the behavior-occurrence vehicle, the behavior occurrence information which is transmitted from the behavior-occurrence vehicle, and the related information processing unit may store the related information in the storage portion.

Accordingly, even when the remote center cannot be used, the behavior occurrence information transmitted from the behavior-occurrence vehicle can be received and the related information can be stored.

The related information processing unit may transmit device information for specifying the own device to the behavior-occurrence vehicle.

Accordingly, even when the remote center cannot be used, the vehicle behavior which has occurred and the related information acquisition device which stores the related information corresponding to the vehicle behavior can be managed in relation to each other in the behavior-occurrence vehicle. As a result, when the related information is read out, a readout instruction can be transmitted to the appropriate related information acquisition device.

The related information acquisition unit may adjust the acquired related information on the basis of the positional relationship between the behavior-occurrence vehicle and the own device.

Accordingly, for example, in the case where image data is acquired as related information, when the related information acquisition device is present at a position at which the behavior-occurrence vehicle cannot be captured, it is possible to prevent acquiring unnecessary image data as related information. Accordingly, the processing load of the related information acquisition device can be reduced.

The related information acquisition unit may adjust the acquired related information on the basis of the classification which is obtained through the behavior-occurrence vehicle's determination as to which one of plural classifications which are set in advance in accordance with the condition of the occurrence of the predetermined vehicle behavior corresponds to and which is transmitted as a part of the behavior occurrence information.

Accordingly, in accordance with the classification of the predetermined vehicle behavior, the related information acquisition device can acquire the appropriate related information related to the predetermined vehicle behavior. For example, it is thought that the length of time used for and the frequency of acquiring the related information are adjusted in response to the classification of the predetermined vehicle behavior.

The related information management unit may transmit, when the related information is stored in the storage portion, the related information stored in the storage portion when directly or indirectly receiving an instruction to read out the related information from the behavior-occurrence vehicle, and may delete the related information stored in the storage portion when directly or indirectly receiving an instruction to delete the related information from the behavior-occurrence vehicle.

Accordingly, when an instruction is issued from the behavior-occurrence vehicle, either directly or indirectly, the related information stored in the storage portion is transmitted and can be deleted.

The vehicular electronic control device may be provided with the means of the related information acquisition device.

Accordingly, when a predetermined vehicle behavior occurs, it is possible to make a request to store the driving information in the own vehicle and to store the related information related, to the predetermined vehicle behavior in the device around the own vehicle by transmitting the behavior occurrence information, and when another vehicle makes a request to store the related information, it is possible to acquire the related information related to the predetermined vehicle behavior occurring in another vehicle.

The above configurations of the embodiments can be combined as appropriate.

The above processings such as calculations and determinations are not limited being executed by the ECU 20 and other processors. The control unit may have various structures including the ECU 20 and other processors shown as an example.

The above processings such as calculations and determinations may be performed by any one or any combinations of software, an electric circuit, a mechanical device, and the like. The software may be stored in a storage medium, and may be transmitted via a transmission device such as a network device. The electric circuit may be an integrated circuit, and may be a discrete circuit such as a hardware logic configured with electric or electronic elements or the like. The elements producing the above processings may be discrete elements and may be partially or entirely integrated.

It should be appreciated that while the processes of the embodiments of the present disclosure have been described herein as including a specific sequence of steps, further alternative embodiments including various other sequences of these steps and/or additional steps not disclosed herein are intended to be within the steps of the present disclosure.

While the present disclosure has been described with reference to preferred embodiments thereof, it is to be understood that the disclosure is not limited to the preferred embodiments and constructions. The present disclosure is intended to cover various modification and equivalent arrangements. In addition, while the various combinations and configurations, which are preferred, other combinations and configurations, including more, less or only a single element, are also within the spirit and scope of the present disclosure.

What is claimed is:

1. A vehicular electronic control device comprising:
a behavior determination unit configured to determine whether or not a predetermined vehicle behavior occurs in an own vehicle;
a driving information storage unit configured to store driving information of the own vehicle in a storage portion when the behavior determination unit determines that the predetermined vehicle behavior occurs; and
a behavior transmission unit configured, when the predetermined vehicle behavior occurs, to transmit behavior occurrence information to an outside of the own vehicle
to notify a related information acquisition device, which is around the own vehicle and configured to acquire related information related to the predetermined vehicle behavior, of the occurrence of the predetermined vehicle behavior and
to require the related information acquisition device to store the related information acquired by the related information acquisition device.

2. The vehicular electronic control device according to claim 1, wherein
the behavior transmission unit is further configured
to transmit the behavior occurrence information to a remote center thereby to cause the remote center to notify the related information acquisition device indirectly of the occurrence of the predetermined vehicle behavior
to require the remote center or the related information acquisition device to store the related information and
to instruct the remote center to manage the related information.

3. The vehicular electronic control device according to claim 2, further comprising:
an information management unit configured
to acquire management information for managing the related information from the remote center, and
to store the management information in the storage portion.

4. The vehicular electronic control device according to claim 3, wherein
the information management unit is further configured, when the driving information storage unit overwrites the driving information stored already in the storage portion,
to transmit the management information, which is stored in relation to the driving information to be overwritten, to the remote center,
to instruct the remote center to delete the related information related to the driving information to be overwritten, and
to store the driving information at this time.

5. The vehicular electronic control device according to claim 3, wherein
the information management unit is further configured, on the basis of the management information stored in the storage portion,
to acquire the related information acquired by the related information acquisition device from the remote center in response to an instruction from a scan tool connected to the own vehicle by communication, and
to instruct the remote center to delete the related information in response to the instruction from the scan tool.

6. The vehicular electronic control device according to claim 1, wherein
the behavior transmission unit is further configured to transmit the behavior occurrence information to the related information acquisition device thereby
directly to notify the related information acquisition device of the occurrence of the predetermined vehicle behavior and
to require the related information acquisition device to store the related information.

7. The vehicular electronic control device according to claim 6, further comprising:
an information management unit configured
to acquire device information for specifying the related information acquisition device from the related information acquisition device and
to store the device information in the storage portion.

8. The vehicular electronic control device according to claim 7, wherein
the information management unit is further configured, when the driving information storage unit overwrites the driving information stored already in the storage portion,
to transmit the device information, which is stored in relation to the driving information to be overwritten, to the related information acquisition device,
to instruct the related information acquisition device to delete the related information related to the driving information to be overwritten, and
to store the driving information at this time.

9. The vehicular electronic control device according to claim 7, wherein
the information management unit is further configured, on the basis of the device information stored in the storage portion,
to acquire the related information stored in the related information acquisition device from the related information acquisition device in response to an instruction from a scan tool connected to the own vehicle by communication, and
to instruct the related information acquisition device to delete the related information in response to the instruction from the scan tool.

10. The vehicular electronic control device according to claim 1, wherein
the behavior determination unit is further configured to determine, in accordance with a condition of occurrence, one of a plurality of classifications, to which the predetermined vehicle behavior, which has occurred, corresponds to, wherein the plurality of classifications is set in advance, and
the behavior transmission unit is further configured to transmit, as a part of the behavior occurrence information, the classification of the predetermined vehicle behavior determined by the behavior determination unit.

11. The vehicular electronic control device according to claim 1, wherein the behavior transmission unit is further configured to transmit, as a part of the behavior occurrence information, own vehicle information for specifying the own vehicle.

12. A related information acquisition device comprising:
a behavior acquisition unit configured to acquire behavior occurrence information for notifying occurrence of a predetermined vehicle behavior in a behavior-occurrence vehicle, the behavior-occurrence vehicle being configured to store driving information of the own vehicle in a storage portion when the predetermined vehicle behavior occurs;
a related information acquisition unit configured, when the behavior acquisition unit acquires the behavior occurrence information, to acquire related information related to the predetermined vehicle behavior; and
a related information processing unit configured,
when the behavior occurrence information does not instruct the own device to store the related information acquired by the related information acquisition unit, to transmit the related information to an other device configured to store the related information, and
when the behavior occurrence information instructs the own device to store the related information, to store the related information in the storage portion.

13. The related information acquisition device according to claim 12, wherein the behavior acquisition unit is further configured to acquire, indirectly from a remote center, the behavior occurrence information transmitted from the behavior-occurrence vehicle.

14. The related information acquisition device according to claim 13, wherein
the behavior acquisition unit is further configured to acquire the behavior occurrence information indirectly from the remote center, and
the related information processing unit is further configured, when the behavior occurrence information does not instruct the own device to store the related information, to transmit the related information to the remote center equipped with the other device.

15. The related information acquisition device according to claim 13, wherein the related information processing unit is further configured to transmit device information for specifying the own device to the remote center.

16. The related information acquisition device according to claim 12, wherein
the behavior acquisition unit is further configured to receive, directly from the behavior-occurrence vehicle, the behavior occurrence information transmitted from the behavior-occurrence vehicle, and
the related information processing unit is further configured to store the related information in the storage portion.

17. The related information acquisition device according to claim 16, wherein the related information processing unit is further configured to transmit device information for specifying the own device to the behavior-occurrence vehicle.

18. The related information acquisition device according to claim 12, wherein the related information acquisition unit is further configured to adjust the related information to be acquired on the basis of the positional relationship between the behavior-occurrence vehicle and the own device.

19. The related information acquisition device according to claim 12, wherein
the behavior-occurrence vehicle is further configured to determine, in accordance with the condition of the occurrence, one of a plurality of classifications, to which the predetermined vehicle behavior corresponds to, wherein the plurality of classifications is set in advance, and
the related information acquisition unit is further configured to adjust the related information to be acquired on the basis of the classification transmitted as a part of the behavior occurrence information.

20. The related information acquisition device according to claim 12, further comprising:
a related information management unit configured, when directly or indirectly receiving an instruction to read out the related information from the behavior-occurrence vehicle,
to transmit, when the related information is stored in the storage portion, the related information stored in the storage portion, and
to delete, when directly or indirectly receiving an instruction to delete the related information from the behavior-occurrence vehicle, the related information stored in the storage portion.

21. A vehicular electronic control device comprising:
a behavior determination unit configured to determine whether or not a predetermined vehicle behavior occurs in an own vehicle;
a driving information storage unit configured to store driving information of the own vehicle in a storage portion when the behavior determination unit determines that the predetermined vehicle behavior occurs;
a behavior transmission unit configured, when the predetermined vehicle behavior occurs, to transmit behavior occurrence information to an outside of the own vehicle
to notify a related information acquisition device, which is around the own vehicle and configured to acquire related information related to the predetermined vehicle behavior, of the occurrence of the predetermined vehicle behavior and
to require the related information acquisition device to store the related information acquired by the related information acquisition device;
a behavior acquisition unit configured to acquire the behavior occurrence information for notifying occurrence of the predetermined vehicle behavior in a behavior-occurrence vehicle, the behavior-occurrence vehicle being configured to store driving information of the own vehicle in the storage portion when the predetermined vehicle behavior occurs;
a related information acquisition unit configured, when the behavior acquisition unit acquires the behavior occurrence information, to acquire the related information related to the predetermined vehicle behavior; and
a related information processing unit configured,
when the behavior occurrence information does not instruct the own device to store the related information acquired by the related information acquisition unit, to transmit the related information to an other device configured to store the related information, and
when the behavior occurrence information instructs the own device to store the related information, to store the related information in the storage portion.

22. A method for controlling a vehicular electronic control device, the method comprising:
causing the vehicular electronic control device to determine whether or not a predetermined vehicle behavior occurs in an own vehicle;
causing the vehicular electronic control device to store driving information of the own vehicle in a storage portion on determination that the predetermined vehicle behavior occurs; and
causing the vehicular electronic control device, when the predetermined vehicle behavior occurs, to transmit behavior occurrence information to an outside of the own vehicle
to notify a related information acquisition device, which is around the own vehicle and configured to acquire related information related to the predetermined vehicle behavior, of the occurrence of the predetermined vehicle behavior and
to require the related information acquisition device to store the related information acquired by the related information acquisition device.

23. A method for controlling a related information acquisition device, the method comprising:
causing the related information acquisition device to acquire behavior occurrence information, which is for notifying occurrence of a predetermined vehicle behavior, in a behavior-occurrence vehicle, the behavior-occurrence vehicle being configured to store driving information of the own vehicle in a storage portion when the predetermined vehicle behavior occurs;
causing the related information acquisition device, on acquisition of the behavior occurrence information, to acquire related information related to the predetermined vehicle behavior;
causing the related information acquisition device, when the behavior occurrence information does not instruct the own device to store the related information being acquired, to transmit the related information to an other device configured to store the related information; and
causing the related information acquisition device, when the behavior occurrence information instructs the own device to store the related information, to store the related information in the storage portion.

24. A method for controlling a vehicular electronic control device, the method comprising:
causing the vehicular electronic control device to determine whether or not a predetermined vehicle behavior occurs in an own vehicle;
causing the vehicular electronic control device to store driving information of the own vehicle in a storage portion on determination that the predetermined vehicle behavior occurs;
causing the vehicular electronic control device, when the predetermined vehicle behavior occurs, to transmit behavior occurrence information to an outside of the own vehicle
to notify a related information acquisition device, which is around the own vehicle and configured to acquire related information related to the predetermined vehicle behavior, of the occurrence of the predetermined vehicle behavior and
to require the related information acquisition device to store the related information acquired by the related information acquisition device;
causing the vehicular electronic control device to acquire the behavior occurrence information, which is for notifying occurrence of the predetermined vehicle behavior, in a behavior-occurrence vehicle, the behavior-occurrence vehicle being configured to store driving information of the own vehicle in the storage portion when the predetermined vehicle behavior occurs;
causing the vehicular electronic control device, on acquisition of the behavior occurrence information, to acquire the related information related to the predetermined vehicle behavior;
causing the vehicular electronic control device, when the behavior occurrence information does not instruct the own device to store the related information being acquired, to transmit the related information to an other device configured to store the related information; and
causing the vehicular electronic control device, when the behavior occurrence information instructs the own device to store the related information, to store the related information in the storage portion.

25. A non-transitory computer readable medium comprising instructions executed by a computer, the instructions including the method according to claim 22.

26. A non-transitory computer readable medium comprising instructions executed by a computer, the instructions including the method according to claim 23.

27. A non-transitory computer readable medium comprising instructions executed by a computer, the instructions including the method according to claim 24.
